(19) United States
(12) Patent Application Publication
(10) Pub. No.: US 2013/0301050 A1
(43) Pub. Date: Nov. 14, 2013

(54) METHOD AND DEVICE FOR TESTING LIGHT-EMITTING DIODE DIE

(71) Applicant: Kuo-Fong TSENG, Tu-Cheng (TW)

(72) Inventor: Kuo-Fong TSENG, Tu-Cheng (TW)

(73) Assignee: HON HAI PRECISION INDUSTRY CO., LTD., Tu-Cheng (TW)

(21) Appl. No.: 13/593,527

(22) Filed: Aug. 24, 2012

(30) Foreign Application Priority Data
May 14, 2012 (TW) 101117020

(51) Int. Cl. G01J 3/28

(52) U.S. Cl. 356/402

(57) ABSTRACT

A method for testing an LED die includes the following steps: setting control parameters; driving the LED die to emit light by applying an electric current to the LED die under the control parameters; detecting the wavelength of the light emitted by the LED die; and determining whether the LED die meets the predetermined electro-optical properties, based upon the relationship between the control parameters and the wavelength.

### BACKGROUND

1. Technical Field

The present disclosure relates to light-emitting diodes and, particularly, to a testing method and a testing device for a light-emitting diode die.

2. Description of Related Art

Light-emitting diodes include a light-emitting diode die and a package packaging the light-emitting diode die. A wavelength of the light emitted by the light-emitting diode die, which determines whether the light-emitting diode is qualified and acceptable, mainly depends on an electro-optical conversion property of the light-emitting diode die. However, a quality of the light-emitting diode is tested after being packaged. As such, unqualified light-emitting diode dies are only discovered after packaged, which wastes time and materials.

Therefore, it is desirable to provide a testing method and testing device for a LED die which can overcome the above-mentioned shortcomings.

### BRIEF DESCRIPTION OF THE DRAWINGS

FIG. 1 is a flow chart of a testing method for a light-emitting diode die according to a first embodiment.

FIG. 2 is a flow chart of a testing method for a light-emitting diode die according to a second embodiment.

FIG. 3 is a schematic view of a testing device for the light-emitting diode die according to a third embodiment.

FIG. 4 is a schematic view of a processor of the testing device of FIG. 3.

### DETAILED DESCRIPTION

Embodiments of the disclosure will be described with reference to the accompanying drawings.

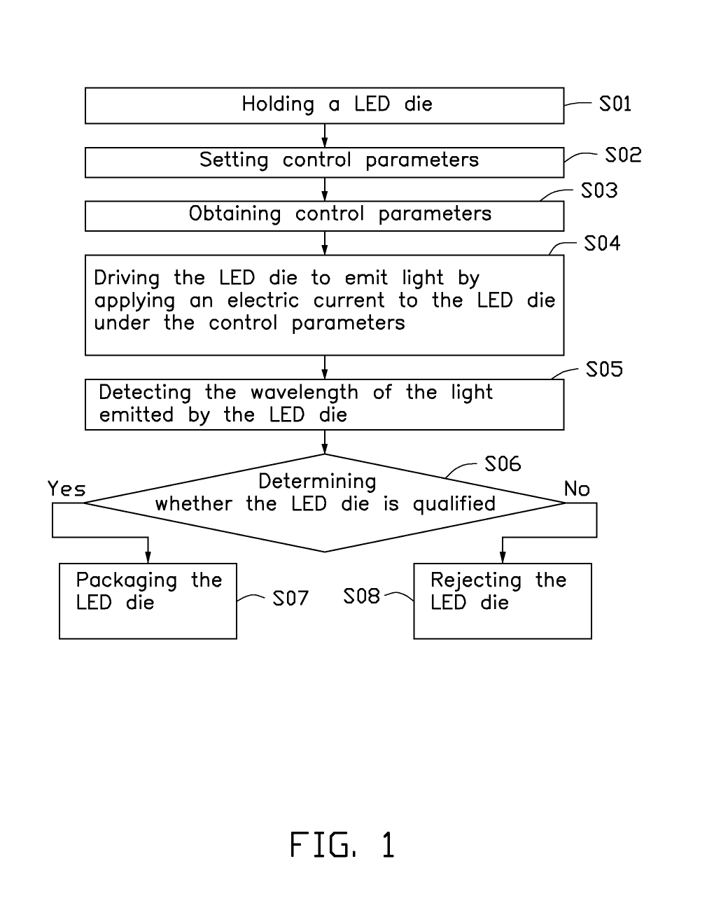

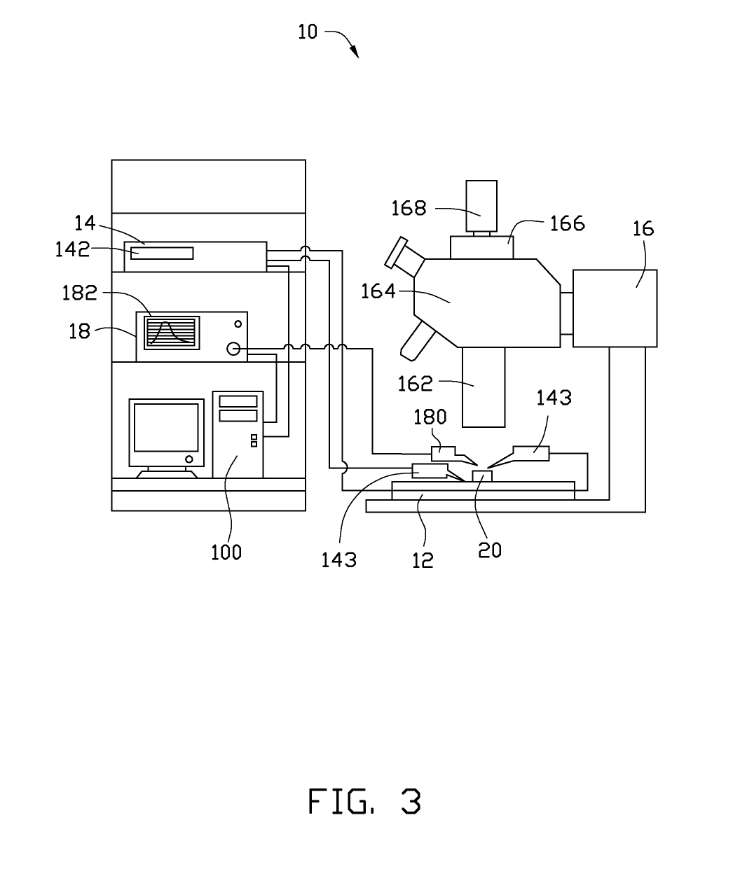

FIG. 1 is a testing method according to a first embodiment. The testing method tests whether a light-emitting diode (LED) die 20 (see FIG. 3) has certain electro-optical properties (is qualified). If qualified, the LED die 20 is packaged into LED package. The testing method includes the following steps S01-S08.

In step S01, holding the LED die 20.

In step S02, setting control parameters.

In step S03, obtaining control parameters.

In step S04, driving the LED die 20 to emit light by applying an electric current to the LED die 20 under the control parameters.

In step S05, detecting the wavelength of the light emitted by the LED die 20.

In step S06, determining whether the LED die 20 is qualified to the predetermined standard(s) based upon the relationship between the control parameters and the wavelength emitted by the LED die 20. If the LED die 20 is qualified, the testing method goes to step S07, otherwise, the testing method goes to step S08.

In the step S07, packaging the LED die 20.

In the step S08, rejecting the LED die 20.

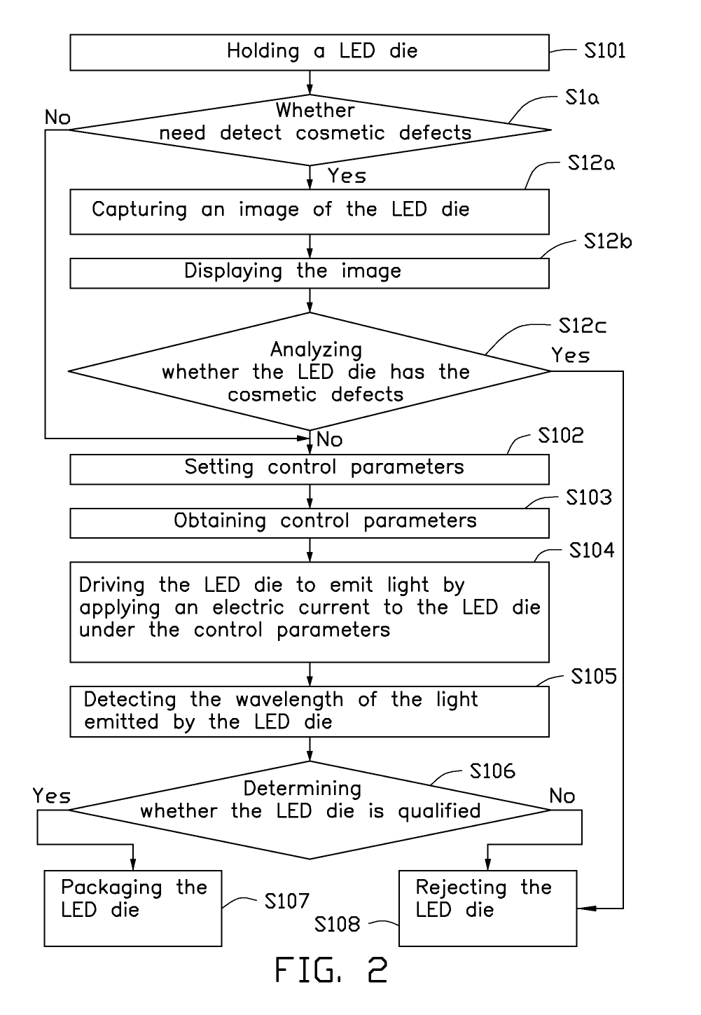

FIG. 2 is a testing method according to a second embodiment. The testing method tests whether the light-emitting diode (LED) die 20 (see FIG. 3) is qualified. If qualified, the LED die 20 is packaged into LED package. The testing method includes the following steps S101-S112.

In step S101, holding the LED die 20.

In step S1a, determining whether any cosmetic defects of the LED die 20 are apparent and need to be investigated. If it is determined that any cosmetic defects of the LED die 20 are insignificant, the testing method goes to step S102.

In step S12a, capturing an image of the LED die 20.

In step S12b, displaying the image of the LED die 20.

In step S12c, analyzing if the LED die 20 has the cosmetic defects based upon the image of the LED die 20. If the LED die 20 has no cosmetic defects, the testing method goes to the step S102. Otherwise, the LED die 20 is rejected and is not packaged.

In step S102, setting control parameters.

In step S103, obtaining control parameters.

In step S104, driving the LED die 20 to emit light by applying an electric current to the LED die 20 under the control parameters.

In step S105, detecting the wavelength(s) of the light emitted by the LED die 20.

In step S106, determining whether the LED die 20 is qualified to the predetermined standard(s) based upon the relationship between the control parameters and the wavelength emitted by the LED die 20. If the LED die 20 is qualified, the testing method goes to step S107, otherwise, the testing method goes to step S08.

In the step S107, packaging the LED die 20.

In the step S108, rejecting the LED die 20.

FIG. 3 shows a testing device 10 for implementing the testing methods of FIGS. 1-2, according to a third embodiment. The testing device 10 includes a chuck 12, a power supply 14, a support 16, a spectrum analyzer 18, and a processor 100.

The LED die 20 is held by the chuck 12. That is, the step S01 of FIG. 1 or step 101 of FIG. 2 can be carried out on the LED die 20 held in the chuck 12. In other embodiments, the LED die 20 can be held by other devices/methods.

The power supply 14 includes a current and voltage meter 142 and two probes 143. The two probes 143 can electrically connect to the anode electrode and to the cathode electrode of the LED die 20. The two probes 143 are configured to supply electric current provided by the power supply 14 across the LED die 20 to make the LED die 20 emit light. The current and voltage meter 142 is configured to measure and display the current and voltage values output by the power supply 14. As such, an output power of the power supply 14 can be calculated according to the current and voltage output values. In the embodiment, the current and voltage meter 142 is integrated in the power supply 14.

The support 16 is positioned on the chuck 12 and includes a first cantilever 162 positioned above the chuck 12.

The spectrum analyzer 18 detects the wavelength of the light emitted by the LED die 20. One end of a fiber 180 is connected to the spectrum analyzer 18, and the other end of the fiber 180 is positioned above the LED die 20. Light emitted by the LED die 20 is transmitted to the spectrum analyzer 18 through the fiber 180. The spectrum analyzer 18 includes a displayer 182 for displaying the light wave(s) of the light emitted by the LED die 20.

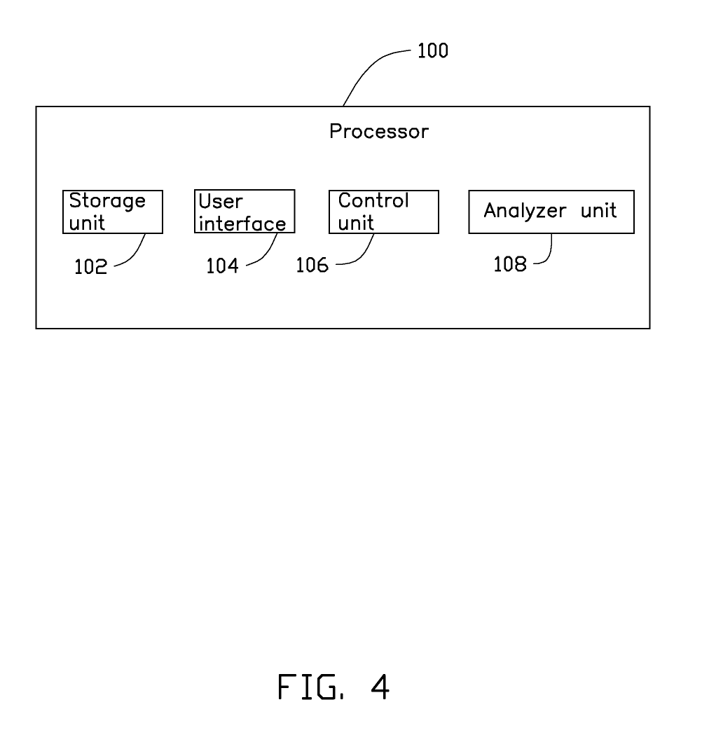

Referring to FIG. 4, the processor 100 is electrically connected to the power supply 14 and to the spectrum analyzer 18. The processor 100 includes a storage unit 102, a user interface 104, a control unit 106, and an analyzer unit 108.

The storage unit 102 stores a number of standard ranges of the wavelength of the light expected to be emitted by the LED die 20. Each of the standard ranges corresponds to an output power level of the power supply 14. For example, when the power supply 14 outputs 20 watts of power to the LED die 20, the corresponding standard range of the wavelength of the emitted light is 600-625 nm; when the power supply 14 outputs 25 watts of power to the LED die 20, the corresponding standard range of the wavelength is 626-650 nm.

The user interface 104 receives user inputs for determining the control parameters of the power supply 14. That is, step S02 is carried out by means of the user interface 104.

The control unit 106 receives the control parameters and controls the two probes 143 of the power supply 14 to output a certain level of electric current across the LED die 20 to make the LED die 20 emit light. That is, the power supply 14 and the control unit 106 cooperatively implement the steps S03-S04 of FIG. 1 and steps S103-S104. The control unit 106 also controls the spectrum analyzer 18 to detect the wavelength of the light emitted by the LED die 20, according to the display on the displayer 182. That is, the spectrum analyzer 18 and the control unit 106 cooperatively implement the step S05 of FIG. 1 and step S105 of FIG. 2.

The analyzer unit 108 analyzes whether or not the electro-optical properties of the LED die 20 achieve the required and predetermined electro-optical properties, according to the power supply output power value and the wavelength of light emitted. That is, the analyzer unit 108 and the user interface 104 cooperatively implement the step S06 and the step S106. If the control unit 106 controls the power supply 14 to output a certain level of power to the LED die 20, the analyzer unit 108 analyzes the wavelength of the light emitted by the LED die 20 for the determination as to whether the wavelength emitted fall within the standard range corresponding to the output power of the power supply 14. If the wavelength of the light emitted by the LED die 20 falls within the standard range corresponding to the output power of the power supply 14, the LED die 20 is deemed to be qualified. Otherwise, the LED die 20 is rejected and is not packaged.

As such, an unqualified LED die 20 can be found immediately after creation and thus avoid being packaged which saves time and materials. In addition, the testing can be implemented efficiently and under standard criteria by the testing device and testing method.

The support 16 can further include a rotary plate 164, a second cantilever 166, and a camera module 168. The first cantilever 162 extends from the rotary plate 164. The second cantilever 166 also extends from the rotary plate 164. The camera module 168 is positioned on the second cantilever 166 and can be positioned to directly point to the LED die 20 by rotating the rotary plate 164.

In steps S12a-S12c, if it is determined that any cosmetic defects of the LED die 20 need to be detected and analyzed, the camera module 168 is positioned to directly face the LED die 20 by rotating the rotary plate 164 and is then actuated to capture an image of the LED die 20. That is, the camera module 168 and the rotary plate 164 cooperatively implement the steps 12a-12c.

Particular embodiments are shown here and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

1. A testing device for testing a light-emitting diode (LED) die, the testing device comprising:
a power supply for supplying an electric current to cross the LED die to make the LED die emit light;
a spectrum analyzer configured to detect the wavelength of the light emitted by the LED die; and
a processor in communication with the power supply and the spectrum analyzer, the processor comprising:
a storage unit storing a plurality of standard ranges of wavelengths of lights emitted by a qualified LED die, each of the standard ranges corresponding to an output power level of the power supply;
a user interface configured for receiving user inputs, thus to determine control parameters of the power supply;
a control unit configured for receiving the control parameters and controlling the power supply to output a certain level of electric current across the LED die to make the LED die emit light under the control parameters, the control unit also controlling the spectrum analyzer to detect the wavelength of the light emitted by the LED die and detected by the spectrum analyzer; and
an analyzer unit configured for analyzing whether or not electro-optical properties of the LED die achieve the required and predetermined electro-optical properties, according to a power value supplied by the power supply to the LED die, and the wavelength of the light emitted by the LED die.

2. The testing device of claim 1, wherein the power supply comprises a current and voltage meter to display the current and voltage values output by the power supply.

3. The testing device of claim 2, wherein the power supply comprises two probes for electrically connecting to an anode electrode and a cathode electrode of the LED die.

4. The testing device of claim 1, further comprising a chuck to hold the LED die.

5. The testing device of claim 4, further comprising a support and a first cantilever, wherein the support is positioned on the chuck, the first cantilever is positioned above the chuck.

6. The testing device of claim 5, wherein the support comprises a rotary plate, a second cantilever and a camera module, the first cantilever extends from the rotary plate, the second cantilever extends from the rotary plate, the camera module is positioned on the second cantilever and can be positioned to directly face the LED die by rotating the rotary plate.

7. A method for testing an LED die, the method comprising:
setting control parameters;
driving the LED die to emit light by applying an electric current to the LED die under the control parameters;
detecting the wavelength of the light emitted by the LED die; and
determining whether the LED die meets the predetermined electro-optical properties, based upon a relationship between the control parameters and the wavelength of the light.

8. The method of claim 7, wherein before the step of setting control parameters, the method comprises:
capturing an image of the LED die;
displaying the image; and
analyzing whether or not the LED die has cosmetic defects based upon the image of the LED die.
